(19) United States
(12) Patent Application Publication
(10) Pub. No.: US 2025/0389648 A1
(43) Pub. Date: Dec. 25, 2025

(54) NESTED MULTI-PASS AND RESONANT SPECTROSCOPY GAS CELL

(71) Applicant: Honeywell International Inc., Charlotte, NC (US)

(72) Inventors: Chen Feng, Mount Laurel, NJ (US); Moin Saghir Shafai, Plano, TX (US); Seong Eyl Lee, Allen, TX (US)

(21) Appl. No.: 18/753,862

(22) Filed: Jun. 25, 2024

(51) Int. Cl. G01N 21/3504; G01N 21/359

(52) U.S. Cl. CPC G01N 21/3504; G01N 21/359; G01N 2201/0636

(57) ABSTRACT

A spectroscopic gas cell is provided. For example, a spectroscopic gas cell comprises a cylindrical body defining a chamber for receiving a gas to be analyzed, an inlet, an outlet, and first and second mirrors affixed at opposite ends of the cylindrical body. The first mirror has a first coating of a first coating type positioned at its center and a second coating of a second coating type positioned circumferentially surrounding the first coating. The second mirror has a first coating of the first coating type positioned at its center and a second coating of the second coating type positioned circumferentially surrounding the first coating. A resonant light path is formed between the first coating of the first mirror and first coating of the second mirror. A multi-pass light path is formed between the second coating of the first mirror and the second coating of the second mirror.

### FIELD OF THE INVENTION

Embodiments of the present disclosure generally relate to gas spectroscopy, and, more particularly, to gas cells for use in gas spectroscopy.

### BACKGROUND

Optical absorption spectroscopic gas sensors are used to detect a target gas or gases (e.g., a dangerous gas) in a sample of gas (e.g., ambient air). Such spectroscopic gas sensors introduce the gas sample into a gas cell, introduce light (e.g., laser light) into the gas cell (some of which is absorbed by the target gas molecules), and analyze the light that exits the gas cell to determine the presence and concentration of the target gas(es). A long optical path for the light is needed to detect low concentrations of the target gas and/or target gases that have low absorption.

Such optical absorption spectroscopic gas sensors are plagued by technical challenges and limitations. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to spectroscopic gas cells, systems for gas spectroscopy, and methods for gas spectroscopy.

In accordance with various embodiments of the present disclosure, a spectroscopic gas cell is provided. In some embodiments, a spectroscopic gas cell comprises a cylindrical body defining a chamber for receiving a gas to be analyzed, an inlet via which the gas to be analyzed is added to the chamber, an outlet via which the gas to be analyzed is removed from the chamber, a first mirror affixed to and closing off a first end of the cylindrical body, and a second mirror affixed to and closing off a second end of the cylindrical body. The first mirror has a first coating of a first coating type positioned at its center and a second coating of a second coating type positioned circumferentially surrounding the first coating. The second mirror has a first coating of the first coating type positioned at its center and a second coating of the second coating type positioned circumferentially surrounding the first coating. The first coating type is selected such that a resonant light path is formed between the first coating of the first mirror and first coating of the second mirror. The second coating type is selected such that a multi-pass light path is formed between the second coating of the first mirror and the second coating of the second mirror.

In some embodiments, the first mirror defines a light inlet through-hole, and the second mirror defines a light outlet through-hole.

In some embodiments, the light inlet through-hole is conical, and the light outlet through-hole is conical. In some embodiments, each of the light inlet through-hole and the light outlet through-hole have their smaller opening on the reflective, mirror-coated side and their larger opening on the opposite side.

In some embodiments, the gas cell is adapted to receive narrowband light through the center of the first mirror such that the narrowband light bounces back and forth and resonates between the first coating of the first mirror and the first coating of the second mirror and exits the gas cell through the center of the second mirror, and the gas cell is adapted to receive wideband light through the light inlet through-hole such that the wideband light bounces back and forth between the second coating of the first mirror and the second coating of the second mirror and exits the gas cell through the light outlet through-hole.

In some embodiments, the narrowband light has a wavelength range of less than 200 nanometers (nm), and the wideband light has a wavelength range of greater than 1000 nm.

In some embodiments, the first coating has a spectral range of less than 200 nm, and the second coating has a spectral range greater than 1000 nm.

In some embodiments, the first coating type has a higher reflectance that the second coating type.

In some embodiments, the first mirror has an anti-reflective coating on a side opposite the first coating and the second coating, and the second mirror has an anti-reflective coating on a side opposite the first coating and the second coating.

In accordance with various embodiments of the present disclosure, a system for gas spectroscopy comprises at least one light emitter, at least one light receiver, and a spectroscopic gas cell as described above.

In accordance with various embodiments of the present disclosure, a method for gas spectroscopy comprises providing a spectroscopic gas cell as described above; emitting narrowband light from at least one light emitter through the center of the first mirror such that the narrowband light bounces back and forth and resonates between the first coating of the first mirror and the first coating of the second mirror and exits the gas cell through the center of the second mirror; receiving, by at least one light receiver, the narrowband light that exits the gas cell; emitting wideband light from the at least one light emitter through the light inlet through-hole such that the wideband light bounces back and forth between the second coating of the first mirror and the second coating of the second mirror and exits the gas cell through the light outlet through-hole; and receiving, by the at least one light receiver, the wideband light that exits the gas cell through the light outlet through-hole.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a perspective view of an example spectroscopic gas cell in accordance with example embodiments of the present disclosure;

FIG. 2 is a sectional view of the example spectroscopic gas cell of FIG. 1 along line 2-2;

FIGS. 3A and 3B are views of, respectively, a first mirror and a second mirror of the example spectroscopic gas cell of FIG. 1;

FIG. 4 illustrates the light paths within an example spectroscopic gas cell in accordance with example embodiments of the present disclosure;

FIGS. 5A and 5B illustrate the points of reflection of light on, respectively, a first mirror and a second mirror of an example spectroscopic gas cell in accordance with example embodiments of the present disclosure; and

FIG. 6 is a block diagram of an example system for gas spectroscopy in accordance with example embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

Various embodiments of the present disclosure overcome the above technical challenges and difficulties and provide various technical improvements and advantages. For example, various embodiments of the present disclosure provide an example spectroscopic gas cell. Various embodiments of the present disclosure provide an example system for gas spectroscopy. Various embodiments of the present disclosure provide an example method for gas spectroscopy.

Various embodiments of the present disclosure provide a spectroscopy gas cell (“gas cell”) which combines both a resonant light path and a multi-pass light path in a single cavity. Such a resonant light path provides enhanced detection of low concentration / low detectability gases due to the extremely long equivalent optical path (e.g., thousands of meters), but with a narrow detection range due to the narrowband light. Such a multi-pass light path provides a broad detection range due to the broadband light, but with lower sensitivity due to the shorter equivalent optical path (e.g., tens of meters). Thus, such a gas cell of various embodiments of the present disclosure provides both broadband detection and high sensitivity using a single cavity and the same gas sample. Such a gas cell with both resonant reflection and multi-pass reflection may be termed a nested gas cell. By combining both a resonant light path and a multi-pass light path in a single cavity, various embodiments of the invention simplify the structure of the gas cell, minimize the gas volume needed for testing, and reduce the time and complexity of testing.

In various embodiments, a thermally stable cylindrical body maintains a precise alignment between opposing mirrors to form a resonant path near the cylindrical axis while the peripheral areas of the mirrors are aligned to enable multi-pass reflections. In various embodiments, the interior surfaces of both mirrors are coated with a high reflectivity coating in the center (i.e., around the cylindrical axis) and a broadband reflective coating on the portions of the surfaces surrounding the high reflectivity coating. In various embodiments, the exterior or back sides of the mirrors are coated with an anti-reflective coating.

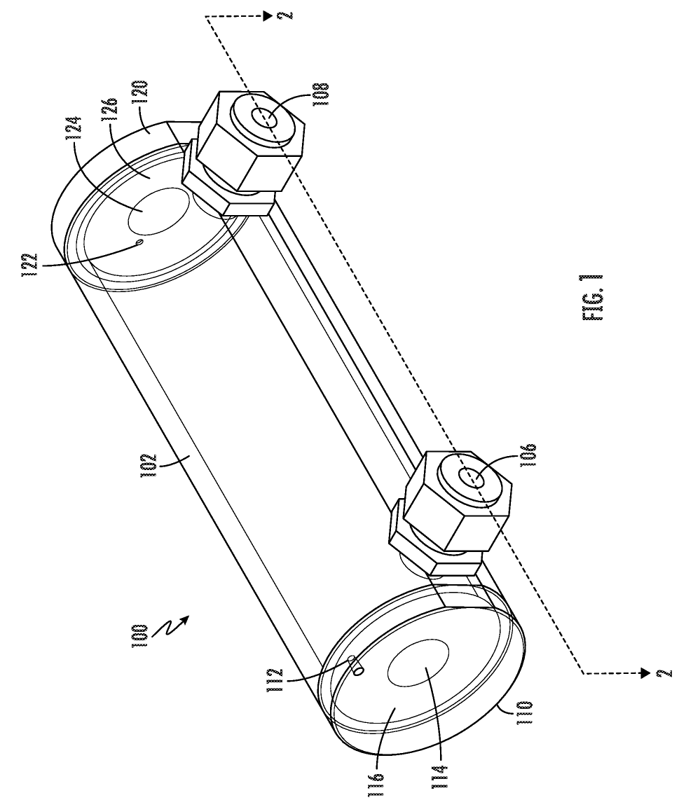

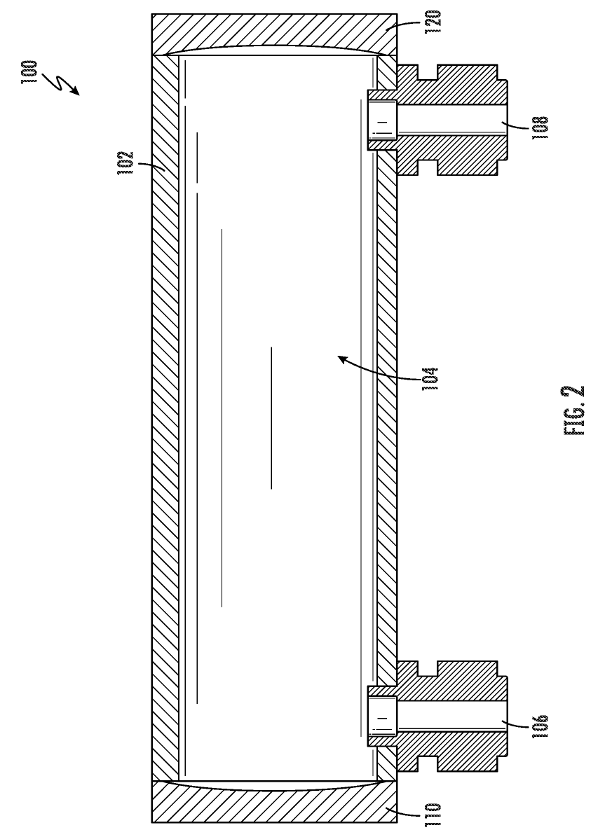

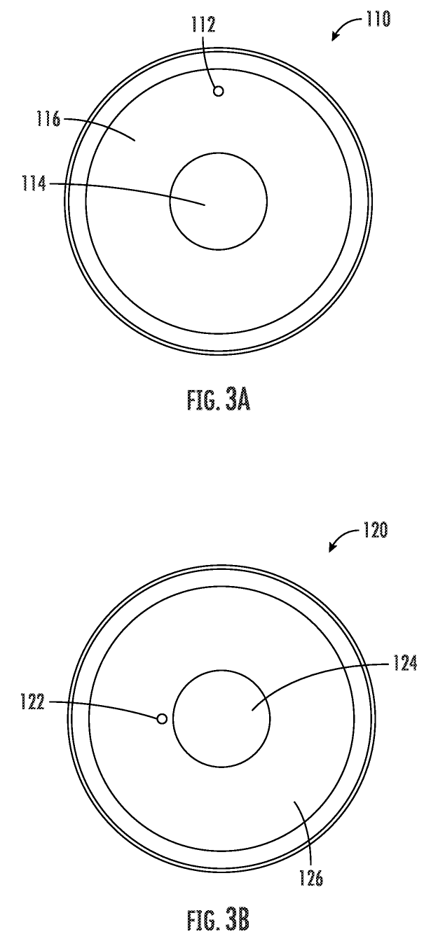

Referring now to FIGS. 1-3, an example spectroscopy gas cell is illustrated in accordance with example embodiments of the present disclosure. The gas cell 100 of FIGS. 1-3 comprises a cylindrical body 102 with a first or inlet mirror 110 and a second or outlet mirror 120 affixed to opposing ends of the cylindrical body 102, thereby defining a cavity or chamber 104 for receiving a gas to be analyzed. The gas cell 100 of FIGS. 1-3 further comprises an inlet 106 via which the gas to be analyzed is added to the chamber 104 and an outlet 108 via which the gas to be analyzed is removed from the chamber 104. In some embodiments, the cylindrical body 102 is constructed of any suitable low thermal expansion material, such as a lithium-aluminosilicate glass-ceramic (e.g., Zerodur produced by Schott AG). In some embodiments, the mirrors 110, 120 are constructed of fused silica or other similar near-infrared optical material.

In various embodiments, the first mirror 110 defines a light inlet through-hole 112 and the second mirror 120 defines a light outlet through-hole 122. In various embodiments, as described further below, wideband light enters the chamber 104 via the light inlet through-hole 112 and exits the chamber 104 via the light outlet through-hole 122. In various embodiments, the light inlet through-hole 112 and the light outlet through-hole 122 are both conical, with each having its larger opening on the exterior side of its respective mirror.

In various embodiments, the first mirror 110 has a first coating 114 of a first coating type positioned at its center and a second coating 116 of a second coating type positioned circumferentially surrounding the first coating 114. Similarly, in various embodiments the second mirror 120 has a first coating 124 of the same first coating type positioned at its center and a second coating 126 of the same second coating type positioned circumferentially surrounding the first coating 124. In various embodiments, the first coating type is a narrowband, ultra high reflectivity dielectric coating selected such that a resonant light cavity is formed between the first coating 114 of the first mirror 110 and the first coating 124 of the second mirror 120. In some embodiments, the first coating type has a reflectance of at least 99.99%, and in one specific example the first coating type has a reflectance of about 99.998%. In various embodiments, the second coating type is a broadband, metal coating selected such that a multi-pass light cavity is formed between the second coating 116 of the first mirror 110 and the second coating 126 of the second mirror 120. In some embodiments, the second coating type has a reflectance of about 97%. In one example embodiment, the first coating type provides ultra high reflectance for light in a range of about 100 nm or less (e.g., about 1500 nm to about 1600 nm). In one example embodiment, the second coating type provides high reflectance for light in a range of about 1100 nm or more (e.g., about 1000 nm to about 2100 nm).

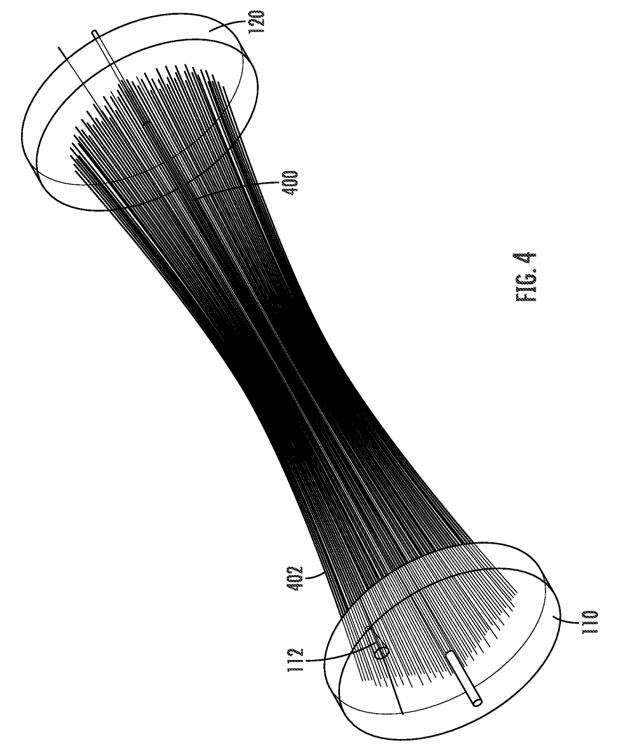

Referring now to FIG. 4 in which the mirrors 110, 120 are shown separate from the cylindrical body to illustrate the resonant light path and the multi-pass light path. As seen in FIG. 4, narrowband light 400 from an emitter, such as one or more optical frequency combs, is emitted at the center of the first mirror 110. At least some of the narrowband light 400 passes through the first mirror 110 and travels within the cavity toward the second mirror 120. Due to the high reflectance of the inner surfaces of the mirrors 110, 120, the narrowband light 400 reflects back and forth between the mirrors 110, 120. In various embodiments, some amount of the resonant narrowband light 400 passes through the second mirror 120 and out of the cavity to be received by a light receiver (such as, for example, an Indium Gallium Arsenide (InGaAs) near-infrared detector).

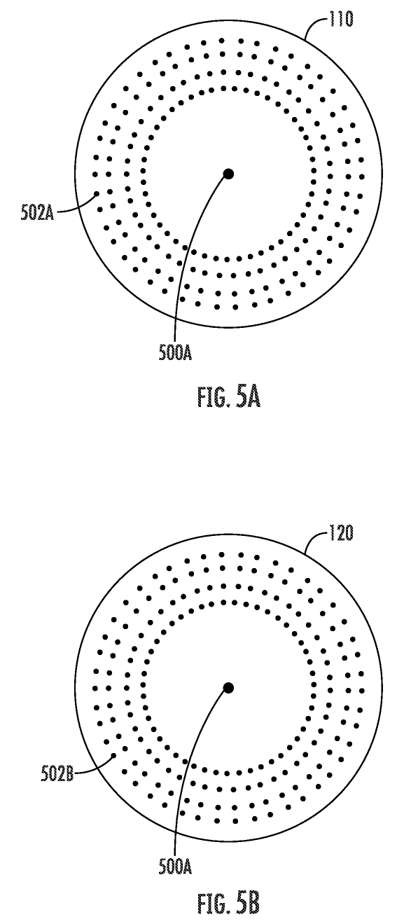

FIG. 5A illustrates the point of reflection 500A of the narrowband light 400 on the first mirror 110, and FIG. 5B illustrates the point of reflection 500B of the narrowband light 400 on the second mirror 120. As seen in FIGS. 5A and 5B, the narrowband light 400 reflects back and forth between substantially the same points on each of the mirrors 110, 120.

The wavelength of narrowband light 400 is selected such that the narrowband light 400 reflected back and forth achieves resonance within the cavity. In some embodiments, the ultra high reflectance (about 99.998% in some embodiments) of the mirrors 110, 120 can achieve a finesse greater than 100000 and an equivalent optical path of thousands of meters, thereby increasing the ability to detect low concentrations of the target gas and/or target gases that have low absorption. In various embodiments, the spectral range of the resonant light path is only few hundred nanometers.

As seen in FIG. 4, broadband light 402 from an emitter, such as one or more optical frequency combs, is emitted at and passes through the light inlet through-hole 112 of the first mirror 110 into the cavity. The inner surfaces of the mirrors 110, 120 are shaped and positioned such that the broadband light 402 is reflected back and forth between the mirrors 110, 120 according to a pattern that avoids collisions between any of the reflections. In various embodiments, after reflecting back and forth according to the pattern determined by the surfaces of the mirrors, the broadband light 402 exits the cavity through the light outlet through-hole 122 defined in second mirror 120 to be received by a light receiver (such as, for example, an Indium Gallium Arsenide (InGaAs) near-infrared detector. FIG. 4 illustrates a reduced number of reflections for simplicity.

Because of the need to avoid collisions between the reflections, there is a limit to how many times the broadband light 402 can be reflected back and forth within the cavity (typically about 200 to about 400 times). FIG. 5B illustrates the points of reflection 502A of the broadband light 402 on the first mirror 110, and FIG. 5B illustrates the points of reflection 502B of the broadband light 402 on the second mirror 120. As seen in FIGS. 5A and 5B, each point of reflection of the broadband light 402 is at a slightly different position on each of the mirrors 110, 120 to avoid collisions between the reflections. In various embodiments, the broad reflectivity of the second coating 116 of each mirror, with around 97% reflectance, enables up to several hundred reflections to form an equivalent optical path of tens of meters. In various embodiments, the spectral range of the multi-pass light path can be wider than 1000 nanometers for detecting a wide range of target gases.

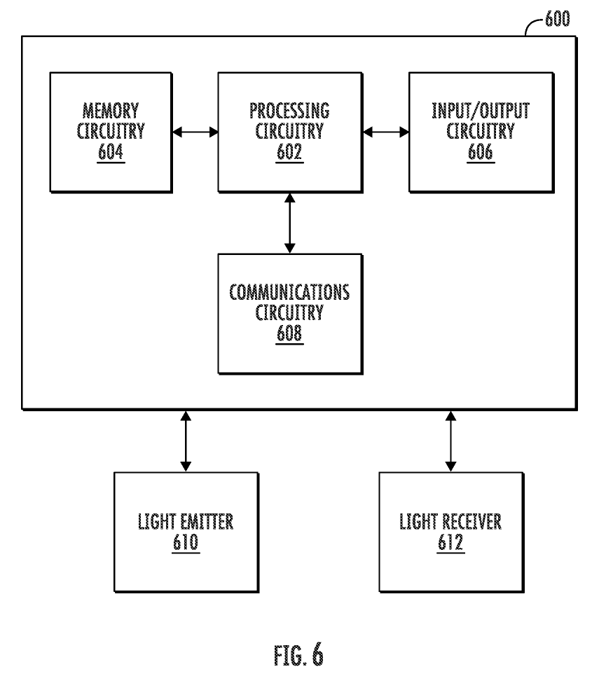

Referring now to FIG. 6, a block diagram of an example spectroscopy system in accordance with example embodiments of the present disclosure is provided. The example system of FIG. 6 includes a control device 600 that controls operation of at least one light emitter 610 that emits light into a gas cell of embodiments of the present disclosure, as described above, and at least one light receiver 612 that receives light that exits the gas cell of embodiments of the present disclosure, as described above, and that analyzes the light received by the at least one light receiver 612 to determine the presence of one or more target gases.

The example control device of FIG. 6 comprises a processor or processing circuitry 602, memory circuitry 604, input/output circuitry 606, and communications circuitry 608. In some embodiments, one or more portions of the example device 600 are configured to execute and perform the operations described herein.

Although components are described with respect to functional limitations, it should be understood that at least some of the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

Processing circuitry 602 may be embodied in a number of different ways. In various embodiments, the use of the terms “processor” or “processing circuitry” should be understood to include a single core processor, a multi-core processor, multiple processors internal to the example device 600, and/or one or more remote or “cloud” processor(s) external to the example device 600. In some example embodiments, processing circuitry 602 may include one or more processing devices configured to perform independently. Alternatively, or additionally, processing circuitry 602 may include one or more processor(s) configured in tandem via a bus to enable independent execution of operations, instructions, pipelining, and/or multithreading.

In an example embodiment, the processing circuitry 602 may be configured to execute instructions stored in the memory circuitry 604 or otherwise accessible to the processor. Alternatively, or additionally, the processing circuitry 602 may be configured to execute hard-coded functionality. As such, whether configured by hardware or software methods, or by a combination thereof, processing circuitry 602 may represent an entity (e.g., physically embodied in circuitry) capable of performing operations according to embodiments of the present disclosure while configured accordingly. Alternatively, or additionally, processing circuitry 602 may be embodied as an executor of software instructions, and the instructions may specifically configure the processing circuitry 602 to perform the various algorithms embodied in one or more operations described herein when such instructions are executed. In some embodiments, the processing circuitry 602 includes hardware, software, firmware, and/or a combination thereof that performs one or more operations described herein.

In some embodiments, the processing circuitry 602 (and/or co-processor or any other processing circuitry assisting or otherwise associated with the processor) is/are in communication with the memory circuitry 604 via a bus for passing information among components of the example device 600.

Memory or memory circuitry 604 may be non-transitory and may include, for example, one or more volatile and/or non-volatile memories. In some embodiments, the memory circuitry 604 includes or embodies an electronic storage device (e.g., a computer readable storage medium). In some embodiments, the memory circuitry 604 is configured to store information, data, content, applications, instructions, or the like, for enabling the example device 600 to carry out various operations and/or functions in accordance with example embodiments of the present disclosure.

Input/output circuitry 606 may be included in the example device 600. In some embodiments, input/output circuitry 606 may provide output to the user and/or receive input from a user. The input/output circuitry 606 may be in communication with the processing circuitry 602 to provide such functionality. The input/output circuitry 606 may comprise one or more user interface(s). In some embodiments, a user interface may include a display that comprises the interface(s) rendered as a web user interface, an application user interface, a user device, a backend system, or the like. In some embodiments, the input/output circuitry 606 also includes a keyboard, a mouse, a joystick, a touch screen, touch areas, soft keys a microphone, a speaker, or other input/output mechanisms. The processing circuitry 602 and/or input/output circuitry 606 may be configured to control one or more operations and/or functions of one or more user interface elements through computer program instructions (e.g., software and/or firmware) stored on a memory accessible to the processor (e.g., memory circuitry 604, and/or the like). In some embodiments, the input/output circuitry 606 includes or utilizes a user-facing application to provide input/output functionality to a computing device and/or other display associated with a user. In some embodiments, the input/output circuitry 606 one or more indicator lights or the like for providing a user notification (e.g., an alert or warning).

Communications circuitry 608 may be included in the example device 600. The communications circuitry 608 may include any means such as a device or circuitry embodied in either hardware or a combination of hardware and software that is configured to receive and/or transmit data from/to a network and/or any other device, circuitry, or module in communication with the example device 600. In some embodiments the communications circuitry 608 includes, for example, a network interface for enabling communications with a wired or wireless communications network. Additionally or alternatively, the communications circuitry 608 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 608 may include circuitry for interacting with an antenna(s) and/or other hardware or software to cause transmission of signals via the antenna(s) and/or to handle receipt of signals received via the antenna(s). In some embodiments, the communications circuitry 608 enables transmission to and/or receipt of data from a user device, one or more sensors (including but not limited to the infrasound sensor 140 and the wideband microphone 142), and/or other external computing device(s) in communication with the example device 600.

In some embodiments, two or more of the sets of circuitry 602-608 are combinable. Alternatively, or additionally, one or more of the sets of circuitry 602-608 perform some or all of the operations and/or functionality described herein as being associated with another circuitry. In some embodiments, two or more of the sets of circuitry 602-608 are combined into a single module embodied in hardware, software, firmware, and/or a combination thereof.

While the description above provides an example device 600, it is noted that the scope of the present disclosure is not limited to the description above. In some examples, an example device 600 in accordance with the present disclosure may be in other forms. In some examples, an example device 600 may comprise one or more additional and/or alternative elements, and/or may be structured differently than that illustrated in FIG. 6.

Operations and processes described herein support combinations of means for performing the specified functions and combinations of operations for performing the specified functions. It will be understood that one or more operations, and combinations of operations, may be implemented by special purpose hardware-based computer systems which perform the specified functions, or combinations of special purpose hardware and computer instructions.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

The foregoing method and process descriptions are provided merely as illustrative examples and are not intended to require or imply that the steps of the various embodiments must be performed in the order presented. As will be appreciated by one of skill in the art the order of steps in the foregoing embodiments may be performed in any order. Words such as "thereafter," "then," "next," and similar words are not intended to limit the order of the steps; these words are simply used to guide the reader through the description of the methods. Further, any reference to claim elements in the singular, for example, using the articles "a," "an" or "the," is not to be construed as limiting the element to the singular and may, in some instances, be construed in the plural.

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the "Background" is not to be construed as an admission that certain technology is prior art to any disclosure in this disclosure. Neither is the "Summary" to be considered as a limiting characterization of the disclosure set forth in issued claims. Furthermore, any reference in this disclosure to "disclosure" or "embodiment" in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. A spectroscopic gas cell comprising:
a cylindrical body defining a chamber for receiving a gas to be analyzed;
an inlet via which the gas to be analyzed is added to the chamber;
an outlet via which the gas to be analyzed is removed from the chamber;
a first mirror affixed to and closing off a first end of the cylindrical body, the first mirror having a first coating of a first coating type positioned at its center and a second coating of a second coating type positioned circumferentially surrounding the first coating; and
a second mirror affixed to and closing off a second end of the cylindrical body, the second mirror having a first coating of the first coating type positioned at its center and a second coating of the second coating type positioned circumferentially surrounding the first coating;
wherein the first coating type is selected such that a resonant light path is formed between the first coating of the first mirror and first coating of the second mirror; and
wherein the second coating type is selected such that a multi-pass light path is formed between the second coating of the first mirror and the second coating of the second mirror.

2. The gas cell of claim 1, wherein the first mirror defines a light inlet through-hole; and
wherein the second mirror defines a light outlet through-hole.

3. The gas cell of claim 2, wherein the light inlet through-hole is conical; and
wherein the light outlet through-hole is conical.

4. The gas cell of claim 2, wherein the gas cell is adapted to receive narrowband light through the center of the first mirror such that the narrowband light bounces back and forth and resonates between the first coating of the first mirror and the first coating of the second mirror and exits the gas cell through the center of the second mirror; and
wherein the gas cell is adapted to receive wideband light through the light inlet through-hole such that the wideband light bounces back and forth between the second coating of the first mirror and the second coating of the second mirror and exits the gas cell through the light outlet through-hole.

5. The gas cell of claim 4, wherein the narrowband light has a wavelength range of less than 200 nanometers (nm); and
wherein the wideband light has a wavelength range of greater than 1000 nm.

6. The gas cell of claim 1, wherein the first coating has a spectral range of less than 200 nm; and
wherein the second coating has a spectral range greater than 1000 nm.

7. The gas cell of claim 1, wherein the first coating type has a higher reflectance that the second coating type.

8. The gas cell of claim 1, wherein the first mirror has an anti-reflective coating on a side opposite the first coating and the second coating; and
wherein the second mirror has an anti-reflective coating on a side opposite the first coating and the second coating.

9. A system for gas spectroscopy, the system comprising:
at least one light emitter;
at least one light receiver; and
a spectroscopic gas cell comprising:
a cylindrical body defining a chamber for receiving a gas to be analyzed;
an inlet via which the gas to be analyzed is added to the chamber;
an outlet via which the gas to be analyzed is removed from the chamber;
a first mirror affixed to and closing off a first end of the cylindrical body, the first mirror having a first coating of a first coating type positioned at its center and a second coating of a second coating type positioned circumferentially surrounding the first coating; and
a second mirror affixed to and closing off a second end of the cylindrical body, the second mirror having a first coating of the first coating type positioned at its center and a second coating of the second coating type positioned circumferentially surrounding the first coating;
wherein the first coating type is selected such that a resonant light path is formed between the first coating of the first mirror and first coating of the second mirror; and
wherein the second coating type is selected such that a multi-pass light path is formed between the second coating of the first mirror and the second coating of the second mirror.

10. The system of claim 9, wherein the first mirror defines a light inlet through-hole; and
wherein the second mirror defines a light outlet through-hole.

11. The system of claim 10, wherein the light inlet through-hole is conical; and
wherein the light outlet through-hole is conical.

12. The system of claim 10, wherein the gas cell receives narrowband light from the at least one light emitter through the center of the first mirror such that the narrowband light bounces back and forth and resonates between the first coating of the first mirror and the first coating of the second mirror and exits the gas cell through the center of the second mirror to be received by the at least one light receiver; and
wherein the gas cell receives wideband light from the at least one light emitter through the light inlet through-hole such that the wideband light bounces back and forth between the second coating of the first mirror and the second coating of the second mirror and exits the gas cell through the light outlet through-hole to be received by the at least one light receiver.

13. The system of claim 12, wherein the narrowband light has a wavelength range of less than 200 nm; and
wherein the wideband light has a wavelength range of greater than 1000 nm.

14. The system of claim 9, wherein the first coating has a spectral range of less than 200 nm; and
wherein the second coating has a spectral range greater than 1000 nm.

15. The system of claim 9, wherein the first coating type has a higher reflectance that the second coating type.

16. The system of claim 9, wherein the first mirror has an anti-reflective coating on a side opposite the first coating and the second coating; and
wherein the second mirror has an anti-reflective coating on a side opposite the first coating and the second coating.

17. A method of gas spectroscopy comprising:
providing a spectroscopic gas cell comprising:
a cylindrical body defining a chamber for receiving a gas to be analyzed;
an inlet via which the gas to be analyzed is added to the chamber;
an outlet via which the gas to be analyzed is removed from the chamber;
a first mirror affixed to and closing off a first end of the cylindrical body, the first mirror having a first coating of a first coating type positioned at its center and a second coating of a second coating type positioned circumferentially surrounding the first coating, the first mirror defining a light inlet through-hole;and
a second mirror affixed to and closing off a second end of the cylindrical body, the second mirror having a first coating of the first coating type positioned at its center and a second coating of the second coating type positioned circumferentially surrounding the first coating, the second mirror defining a light outlet through-hole;
wherein the first coating type is selected such that a resonant light path is formed between the first coating of the first mirror and first coating of the second mirror; and
wherein the second coating type is selected such that a multi-pass light path is formed between the second coating of the first mirror and the second coating of the second mirror; emitting narrowband light from at least one light emitter through the center of the first mirror such that the narrowband light bounces back and forth and resonates between the first coating of the first mirror and the first coating of the second mirror and exits the gas cell through the center of the second mirror;
receiving, by at least one light receiver, the narrowband light that exits the gas cell;
emitting wideband light from the at least one light emitter through the light inlet through-hole such that the wideband light bounces back and forth between the second coating of the first mirror and the second coating of the second mirror and exits the gas cell through the light outlet through-hole; and
receiving, by the at least one light receiver, the wideband light that exits the gas cell through the light outlet through-hole.

18. The method of claim 17, wherein the first coating has a spectral range of less than 200 nm; and
wherein the second coating has a spectral range greater than 1000 nm.

19. The method of claim 17, wherein the first coating type has a higher reflectance that the second coating type.

20. The method of claim 17, wherein the first mirror has an anti-reflective coating on a side opposite the first coating and the second coating; and
wherein the second mirror has an anti-reflective coating on a side opposite the first coating and the second coating.
